(19) United States
(12) Patent Application Publication
(10) Pub. No.: US 2017/0369280 A1
(43) Pub. Date: Dec. 28, 2017

(54) BUFFERING DEVICE FOR MULTIPLE-CAR ELEVATOR SYSTEM

(71) Applicant: Otis Elevator Company, Farmington, CT (US)

(72) Inventor: Randall Keith ROBERTS, Hebron, CT (US)

(21) Appl. No.: 15/545,174

(22) PCT Filed: Jan. 18, 2016
(86) PCT No.: PCT/US2016/013781

§ 371 Date: Jul. 20, 2017

Related U.S. Application Data
(60) Provisional application No. 62/105,807, filed on Jan. 21, 2015.

(51) Int. Cl. B66B 5/28; B66B 9/00; B66B 11/04

(52) U.S. Cl. CPC B66B 5/286; B66B 11/0407; B66B 5/288; B66B 9/003

(57) ABSTRACT

An elevator system includes a first elevator car (14A) supported for vertical movement in a lane (11, 13, 15, 17) of a hoistway (11). A second elevator car (14B) is configured to operate and move vertically in the lane (11, 13, 15, 17) below the first elevator car (14A) independently thereof. At least one buffering device (34) is supported on at least one of the elevator cars (14) to absorb energy upon contact between each buffering device (034) and the other elevator car (14).

### FIELD OF INVENTION

The subject matter disclosed herein relates generally to the field of elevators and, more particularly, to a multi-car elevator system.

### BACKGROUND

Ropeless elevator systems, also referred to as “self-propelled elevator systems,” are useful in certain applications (e.g., high-rise buildings) where the mass of the ropes for a roped system is prohibitive and there is a desire for multiple elevator cars to travel in a single lane of a hoistway. There exist ropeless elevator systems in which a first lane is designated for upward-traveling cars and a second lane is designated for downward-traveling cars. A transfer station at each end of the hoistway is used to move cars horizontally between the first lane and second lane.

### BRIEF DESCRIPTION OF INVENTION

According to a non-limiting exemplary embodiment of the invention, an elevator system includes a first elevator car supported for vertical movement in a lane of a hoistway. A second elevator car is configured to operate and move vertically in the lane below the first elevator car independently thereof. At least one buffering device is supported on at least one of the elevator cars to absorb energy upon contact between each buffering device and the other elevator car.

In an aspect of the embodiment, at least one buffering device is positioned on at least a top portion of the second elevator car and facing toward the first elevator car, and/or at least one buffering device is positioned on at least a bottom portion of the first elevator car and facing toward the second elevator car. In a version of this aspect, at least one buffering device is positioned at least at an upper or a lower part of a linear motor system of at least one of the elevator cars.

In another aspect, at least one first buffering member is positioned on a bottom portion of the first elevator car, and/or at least one second buffering member is positioned on a top portion of the second elevator car. In a version of this aspect, at least one first buffering member is positioned on a bottom portion of the first elevator car, at least one corresponding second buffering member is positioned on a top portion of the second elevator car, and corresponding ones of the first and second buffering members contact each other upon contact between the first and second elevator cars. In an example of this version, the first buffering member includes a reaction plate, and the second buffering member includes a buffer.

In still another aspect, each buffering device is mechanical, electric, magnetic, or any combination thereof. In a version of this aspect, the buffering device includes a spring, a shock absorber (including fluid or not), an electromechanical device, or a repulsive-magnetic-force-generating component.

In yet another aspect, the buffering device is equipped with a sensor to detect the contact, integrity, and/or operability (in a non-contacting state) of the buffering device. The detection and/or a condition of the buffering device are/is readable by a sub-system of the elevator system.

Each buffering device dissipates or minimizes the energy transmitted from one of the elevator cars to the other if the elevator cars contact each other in the lane during operation of the elevator system. In this way, the buffering device manages the mechanical energy of the contact, allowing for safe operation of the elevator system and travel of the elevator cars to respective successive floors of, for example, a high-rise building. Also, reactive forces between the elevator cars are generated, and resetting of the buffering device(s) is not required.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 schematically depicts a non-limiting exemplary embodiment of a multiple-car, ropeless elevator system;

FIG. 2 schematically depicts operation of a buffering device of a multiple-car, ropeless elevator system according to a non-limiting exemplary embodiment of the invention;

FIG. 3 depicts the buffering device according to the embodiment illustrated in FIG. 2 implemented with a frameless car; and

FIG. 4 depicts the buffering device according to the embodiment illustrated in FIG. 2 implemented with a framed car.

### DETAILED DESCRIPTION OF INVENTION

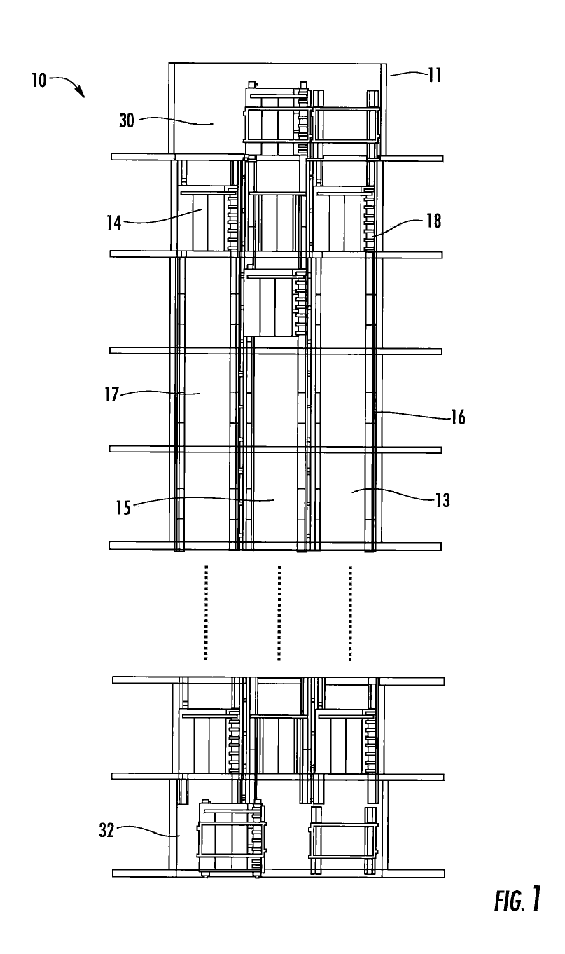

FIG. 1 depicts a non-limiting exemplary embodiment of a multi-car, ropeless elevator system 10. However, it should be understood that the elevator system 10 is not limited to being ropeless. By way of example only, the elevator system 10 can be roped such that buffering devices described below and shown in the figures can be implemented with a roped multi-car system. Also, the buffering devices can be implemented with a ropeless multi-car system that does not include a linear motor.

As shown in FIG. 1, the elevator system 10 includes a hoistway 11 having a plurality of lanes 13, 15, 17. While three lanes 13, 15, 17 are shown in FIG. 1, it should be understood that other embodiments of the elevator system 10 may have any suitable respective number of lanes. In each lane 13, 15, 17, one or more elevator cars 14 travel in one direction (i.e., up or down). For example, in FIG. 1, the cars 14 in lanes 13 and 15 travel up, and the cars 14 in lane 17 travel down.

Above the top floor of the hoistway 11 is an upper transfer station 30 to impart horizontal (or lateral) motion to the cars 14 to move the cars 14 between and among the lanes 13, 15, 17. It should be understood that the upper transfer station 30 may be located at the top floor rather than above the top floor. Below the first floor of the hoistway 11 is a lower transfer station 32 to impart horizontal motion to the cars 14 to move the cars 14 between and among the lanes 13, 15, 17. It should be understood that the lower transfer station 32 may be located at the first floor rather than below the first floor. Although not shown in FIG. 1, at least one intermediate transfer station may be used between the first and top floors. Each intermediate transfer station is similar to the upper and lower transfer stations 30, 32.

The cars 14 are propelled using a linear-magnetic-motor system having a primary, fixed portion 16 and a secondary, moving portion 18. The primary portion 16 includes windings or coils mounted at at least one side of each lane 13, 15, 17. The primary portion 16 also is supplied with drive signals to control movement of the cars 14 in their respective lanes. The secondary portion 18 includes permanent-magnet arrays mounted to at least one side of each car 14 and is designed to react to large loads.

As shown in FIG. 1, adjacent lanes 13, 15, 17 share a guiderail such that, for example, an interior side of the car 14 in lane 13 and a corresponding side of the car 14 in lane 15 travel along a common guiderail. Also as shown in FIG. 1 and described below, in each lane 13, 15, 17, at least one lower car 14 is positioned below an upper car 14, both cars 14 configured to move within the lane 11 as known.

It should be understood that the elevator system 10, in general, and the hoistway 11, upper and lower transfer stations 30, 32 (and any intermediate transfer station), and linear motor system, in particular, can have any suitable structure. It should be understood also that the hoistway 11, lanes 13, 15, 17, upper and lower transfer stations 30, 32 (and any intermediate transfer station), and linear motor system can have any suitable relationship with each other. It should be understood also that each of the cars 14 can move within the hoistway 11 and in the corresponding lane 13, 15, 17 in any suitable manner. It should be understood also that any suitable number of cars 14 can travel in a corresponding lane in any suitable direction. It should be understood also that each of the transfer stations 30, 32 can impart horizontal motion to the cars 14 in any suitable manner. It should be understood also that the cars 14 can be propelled using any suitable propulsion system—e.g., an on-board propulsion (e.g., on-board rotary magnetic screws) such that structure of each car 14 may be more similar to that of a conventional rope-elevator car including a frame through which propulsion is directed. It should be understood also that, in the case of a ropeless elevator system, the cars 14 thereof can be propelled using any suitable propulsion system as well.

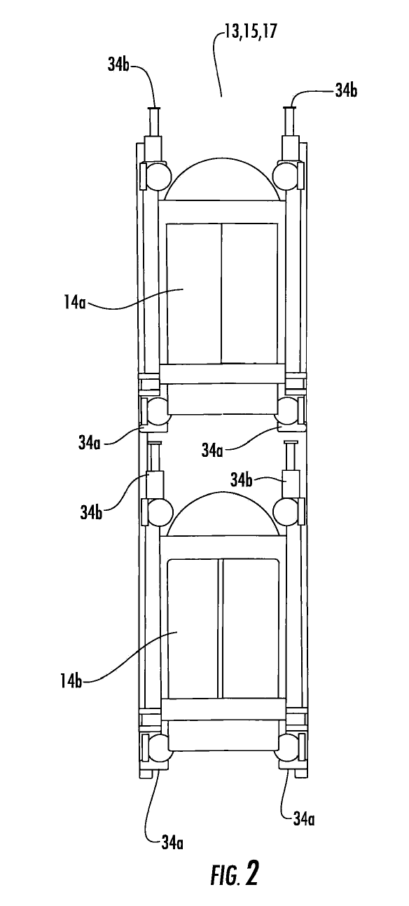

FIG. 2 depicts operation of a buffering device 34 of the elevator system 10 according to a non-limiting exemplary embodiment. In the figure, an upper or first car 14a is supported for vertical movement in a corresponding lane 13, 15, 17. A lower or second car 14b is configured to operate and move vertically in the lane 13, 15, 17 below the first car 14a independently of the first car 14a. At least one buffering device 34 is supported on at least one of the cars 14a, 14b to absorb energy upon contact between each buffering device 34 and the other car 14a, 14b. The figure shows the two cars 14a, 14b nearly in contact with each other and including respectively four buffering devices 34. It should be understood that, in the case in which the elevator system 10 includes more than two cars 14 in a particular lane 13, 15, 17, “first and second cars 14a, 14b” refer to any pair of adjacent ones of these three or more cars 14.

In an aspect, at least one buffering device 34 is positioned on at least a top portion of the second car 14b and facing toward the first car 14a, and/or at least one buffering device 34 is positioned on at least a bottom portion of the first car 14a and facing toward the second car 14b. In a version of this aspect and as shown in FIG. 2, a pair of buffering devices 34 are supported on a top portion of each of the cars 14a, 14b substantially in-line with the secondary portion 18 of the linear motor system, and a pair of buffering devices 34 are supported on a bottom portion of each of the cars 14a, 14b. In this example, the pair of buffering devices 34 supported on the top portion of the second car 14b and the pair of buffering devices 34 supported on the bottom portion of the first car 14a are configured to respectively contact each other upon contact between with the cars 14a, 14b to, thereby, absorb the contact.

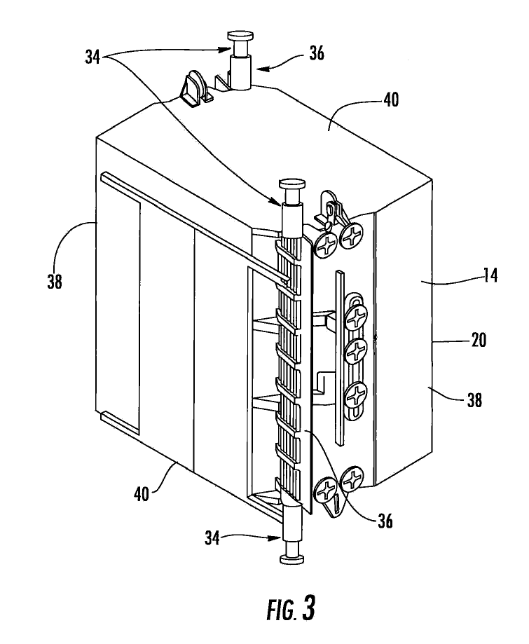

FIG. 3 depicts one or more buffering devices 34 implemented with a frameless car 14. In an aspect, the car 14 includes a cabin 50, and the linear motor system of the car 14 is supported on the cabin 20. (Again, it should be understood that the linear motor system is only one possible vertical propulsion system for the elevator system 10.) A buffering device 34 is positioned at least at an upper or a lower part of a portion of the linear motor system. More specifically, permanent-magnet arrays 36 of the secondary portion 18 of the linear motor system are shown mounted to opposite corners of opposed exterior side walls 38 of the car 14. In a version of this aspect and as shown in the figure, at each corner, a buffering device 34 is positioned at both the upper and lower parts of the secondary portion 18. In particular, a pair of buffering devices 34 are mounted to opposed upper and lower ends of the secondary portion 18 such that the buffering devices 34 are aligned with the secondary portion 18 and extend beyond respective opposed exterior end walls 40 of the car 14. In this way, in a two-car scenario, the buffering devices 34 mounted to the upper ends of the secondary portion 18 of the second car 14b are configured to contact the buffering devices 34 mounted to the lower ends of the secondary portion 18 of the first car 14a upon contact between with the cars 14a, 14b to, thereby, absorb the contact.

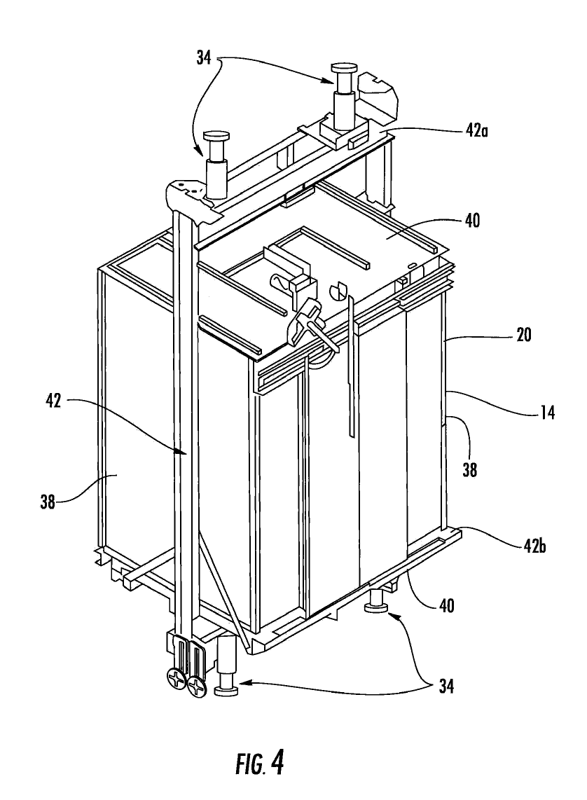

FIG. 4 depicts one or more buffering devices 34 implemented with a framed car 14 (which can be employed in a roped or ropeless multi-car elevator system). The cabin 20 of the car 14 is supported in a known manner on a frame 42 such that members of the frame 42 are operatively mounted to respective exterior side and end walls 38, 40 of the cabin 20. (The frame 42 can connect to a roped or ropeless propulsion system that is not shown directly in FIG. 4.) In an aspect, at least one buffering device 34 is positioned at least at an upper or a lower end of the frame 38. More specifically, the frame 42 includes a crosshead beam 42a along a top of the frame 42 and a plank beam 42b along a bottom of the frame 42. In a version of this aspect and as shown in the figure, a pair of buffering devices 34 are supported at or near each of the beams 42a, 42b and arranged substantially perpendicular to the respective beam 42a, 42b so that the buffering devices 34 extend upward or downward and beyond the respective beam 42a, 42b. Toward that end, a pair of corresponding buffer supports (not shown) can be arranged on each of the crosshead and plank beams 42a, 42b for supporting the buffering devices 34. In this way, in the two-car scenario, the pair of buffering devices 34 supported at or near the crosshead beam 42a of the second car 14b are configured to contact the buffering devices 34 supported at or near the plank beam 42b of the first car 14a upon contact between with the cars 14a, 14b to, thereby, absorb the contact.

It should be understood that, although structure of the frame 42 and various members of the frame 14 shown are conventional, they can be of any suitable structure. It should be understood also that the frame 42 can be operatively mounted to the cabin 20 in any suitable manner. It should be understood also that, in the case of a frameless elevator system, each buffering device 34 is positioned at least at a top or bottom structure of the elevator system. In an aspect of this case, the buffering device 34 is arranged substantially perpendicular to the respective top or bottom structure so that the buffering device 34 extends beyond the structure.

Returning to FIG. 2, in an aspect, the buffering device 34 includes a plurality—in particular, a pair—of members. At least one first buffering member 34a is positioned on a bottom portion of the first car 14a, and/or at least one second buffering member 34b is positioned on a top portion of the second car 14b. In a version of this aspect, the first buffering member 34a includes a reaction plate 34a, and the second buffering member 34b includes a corresponding buffer 34b. The reaction plate 34a is configured to interact with the buffer 34b in the event that the cars 14a, 14b contact each other. As such, the reaction plate 34a is sufficiently strong to act as a reaction surface for the buffer 34b. The reaction plate 34a and buffer 34b operate to dissipate energy associated with such contact. In the example shown, a pair of reaction plates 34a are positioned on the bottom portion of the first car 14a, and a corresponding pair of buffers 34b are positioned on the top portion of the second car 14b. Of course, it should be understood that positioning of the reaction plates 34a and buffers 34b can be reversed so that the pair of reaction plates 34a are positioned on the top portion of the second car 14b and the corresponding pair of buffers 34b are positioned on the bottom portion of the first car 14a.

Each buffering device 34, as an energy-absorbing device, can be made of any suitable number and kind of materials. For instance, each buffering device 34 can be mechanical, electric, magnetic, or any combination thereof. In an aspect, the buffering device includes a spring, a shock absorber (including fluid or not), an electromechanical device, or a repulsive-magnetic-force-generating component. Also, in an aspect, the buffering device 34 is equipped with a sensor—such as a microswitch—to detect the contact, which detection is readable by, for example, an integrity-management system of the elevator system 10. The sensor detects further integrity and/or operability (in a non-contacting state) of the buffering device 34, and a condition or health of the buffering device 34 is readable by a sub-system of the elevator system 10 as well.

In operation, each buffering device 34 is configured to contact a car 14 or another buffering device 34 as two cars 14 come together either during normal operation, such as during landing of the cars 14 at respective successive floors of the hoistway 11 (or otherwise in connection with primary motion control of the cars 14). Upon such contact, the buffering device 34 progressively deforms, thereby effectively dissipating energy associated with the contact. In this way, the buffering device 34 manages potential energy of contact between the cars 14 and can act as a safety back-up to a primary motion controller of the elevator system 10. The sensor detects the contact, which is readable by the integrity-management system of the elevator system 10.

The buffering device 34 can be a multiple-use device or frangible. Also, a simple visual inspection of each buffering device 34 can confirm that the buffering device 34 is intact and operative. The integrity-management system also can be used to verify integrity of the buffering device 34.

Each buffering device 34 dissipates or minimizes the energy transmitted from one of the cars 14 to the other car 14 if the cars 14 contact each other in the lane 13, 15, 17 during operation of the elevator system 10. In this way, the buffering device 34 manages the mechanical energy of the contact, allowing for safe operation of the elevator system 10 and travel of the cars 14 to respective successive floors of, for example, a high-rise building. Also, reactive forces between the cars 14 are generated, and resetting of the buffering device(s) 34 is not required.

In the above embodiments, the buffering devices 34 are on the top and/or bottom of cars 14 to absorb energy in a vertical direction. Similar buffering devices 34 may be employed in the transfer stations 30 and/or 32 to dissipate or minimize the energy transmitted from one of the cars 14 to the other car 14 in a horizontal direction. In such embodiments, the buffers may be positioned on holding carriages within the transfer station that carry and transport the cars 14 horizontally.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. An elevator system comprising:
a first elevator car supported for vertical movement in a lane of a hoistway;
a second elevator car configured to operate and move vertically in the lane below the first elevator car independently thereof; and
at least one buffering device supported on at least one of the elevator cars to absorb energy upon contact between each buffering device and the other elevator car.

2. The elevator system of claim 1, wherein at least one of at least one buffering device is positioned on at least a top portion of the second elevator car and facing toward the first elevator car and at least one buffering device is positioned on at least a bottom portion of the first elevator car and facing toward the second elevator car.

3. The elevator system of claim 2, wherein at least one buffering device is positioned at least at an upper or a lower part of a linear motor system of at least one of the elevator cars.

4. The elevator system of claim 3, wherein at least one buffering device is positioned at an upper or a lower part of a secondary portion of the linear motor system.

5. The elevator system of claim 4, wherein the linear motor system is mounted to an exterior side wall of the elevator car.

6. The elevator system of claim 5, wherein the buffering device is mounted to an upper or lower end of the secondary portion of the linear motor system such that the buffering device is aligned with the secondary portion and extends beyond a respective exterior end wall of the elevator car.

7. The elevator system of claim 1, wherein the buffering device includes a plurality of buffering members and at least one of at least one first buffering member is positioned on a bottom portion of the first elevator car and at least one second buffering member is positioned on a top portion of the second elevator car.

8. The elevator system of claim 7, wherein at least one first buffering member is positioned on a bottom portion of the first elevator car, at least one second buffering member is positioned on a top portion of the second elevator car, and corresponding ones of the first and second buffering members contact each other upon contact between the first and second elevator cars.

9. The elevator system of claim 8, wherein the first buffering member includes a reaction plate and the second buffering member includes a buffer.

10. The elevator system of claim 1, wherein at least one buffering device is positioned at least at a top or bottom structure of the elevator system.

11. The elevator system of claim 10, wherein the buffering device is arranged substantially perpendicular to the respective top or bottom structure so that the buffering device extends beyond the structure.

12. The elevator system of claim 1, wherein each buffering device is any of mechanical, electric, magnetic, and any combination thereof.

13. The elevator system of claim 12, wherein the buffering device includes any of a spring, a shock absorber, an electromechanical device, and a repulsive-magnetic-force-generating component.

14. The elevator system of claim 1, wherein the buffering device is equipped with a sensor to detect at least one of the contact and integrity and operability of the buffering device and at least one of the detection and a condition of the buffering device is readable by the elevator system.

15. The elevator system of claim 1, wherein the buffering device is frangible.

16. An elevator system comprising:
a first elevator car supported for vertical movement in a lane of a hoistway;
a second elevator car configured to operate and move vertically in the lane below the first elevator car independently thereof;
a transfer station for imparting horizontal movement to the first elevator car and the second elevator car; and
at least one buffering device supported in the transfer station to absorb energy upon contact between each buffering device and the other elevator car.
